(19) United States
(12) Patent Application Publication
(10) Pub. No.: US 2026/0268832 A1
(43) Pub. Date: Sep. 10, 2026

(54) DISPLAY PIXEL HAVING A DYNAMIC CURRENT-CALIBRATION

(71) Applicant: GOOGLE LLC, Mountain View, CA (US)

(72) Inventor: Bo Li, Folsom, CA (US)

(21) Appl. No.: 19/164,104

(22) PCT Filed: Apr. 1, 2024
(86) PCT No.: PCT/US2024/022515

§ 371 Date: Sep. 10, 2025

Related U.S. Application Data
(60) Provisional application No. 63/493,863, filed on Apr. 3, 2023.

(51) Int. Cl. G09G 3/32

(52) U.S. Cl. CPC G09G 3/32; G09G 2300/0857; G09G 2320/0257; G09G 2320/045; G09G 2320/0693

(57) ABSTRACT

The present disclosure describes a pixel that can generate a drive current for an LED pixel in an array. The pixel includes circuitry to increase an accuracy of the calibration and to increase a speed at which a calibration can be performed.

### CROSS-REFERENCE TO RELATED APPLICATION

This application claims priority to U.S. Provisional Patent Application No. 63/493,863, filed on Apr. 3, 2023, the disclosure of which is incorporated by reference herein in its entirety.

### FIELD OF THE DISCLOSURE

The present disclosure relates to circuitry for a display and, more specifically, to a circuit for controlling the brightness of a pixel.

### BACKGROUND

A display may include a plurality of pixels that can be controlled independently to radiate at various intensities so that when viewed in combination, the pixels define an image. Further, a pixel may include subpixels that each correspond to a basis color (e.g., red, green, blue) of the visual spectrum. The subpixels of each pixel can be further controlled to illuminate at various intensities so that the light generated by each pixel appears as a particular color determined by the combination of the basis color intensities. In a display, each pixel (or subpixel) may have a corresponding pixel driver circuit. The pixel driver circuit may be configured to supply a current to a pixel based on an intensity scale for the pixel (or subpixel). Visual artifacts in the displayed image may occur when two or more pixels in the display are prescribed the same intensity but are driven to generate different intensities because the current supplied by the pixel drivers are slightly different.

### SUMMARY

The present disclosure describes a microscopic light-emitting-diode display (i.e., micro-LED display) having a hybrid calibration source that can be used, on occasion (i.e., dynamically), to calibrate the pixel drivers of the micro-LED display so that the pixel drivers can provide a calibrated current that is approximately the same for each pixel.

In some aspects, the techniques described herein relate to a pixel including: a first portion including: a current-source transistor coupled at a source terminal to a power supply; and a charge-storage element coupled between a gate terminal of the current-source transistor and the source terminal of the current-source transistor; a calibration transistor configured to couple the gate terminal of the current-source transistor to a drain terminal of the current-source transistor while the pixel is in a calibration mode; and a calibration-source transistor configured to couple the drain terminal of the current-source transistor to a hybrid calibration source while the pixel is in the calibration mode, the hybrid calibration source configured to charge the charge-storage element to a gate-source voltage during a calibration period so that the current-source transistor conducts a calibrated current after the calibration period.

In some aspects, the techniques described herein relate to a method for driving a pixel in a display, the method including: configuring the pixel in a calibration mode by: disconnecting a current-source transistor from a pulse width modulation (PWM) portion of the pixel; and connecting the current-source transistor to a hybrid-calibration source so that the current-source transistor conducts a calibrated current; generating a gate-source voltage at the current-source transistor while the current-source transistor conducts the calibrated current; storing the gate-source voltage in a capacitor coupled between a source terminal of the current-source transistor and a gate terminal of the current-source transistor; and configuring the pixel in a radiation mode by: disconnecting the current-source transistor from the hybrid-calibration source; and connecting the current-source transistor to the PWM portion of the pixel, the PWM portion including a modulation transistor and a light emitting diode (LED).

In some aspects, the techniques described herein relate to a micro-light-emitting-diode (micro-LED) display, including: a hybrid calibration source coupled to a calibration bit line; and a plurality of pixels, each pixel including: a current-source transistor coupled at a source terminal to a power supply; a charge-storage element coupled between a gate terminal of the current-source transistor and the source terminal of the current-source transistor; a calibration transistor configured to couple the gate terminal of the current-source transistor to a drain terminal of the current-source transistor during a calibration period; and a calibration-source transistor configured to couple the drain terminal of the current-source transistor to the calibration bit line during the calibration period so that the hybrid calibration source charges the charge-storage element to a gate-source voltage corresponding to a calibrated current.

The foregoing illustrative summary, as well as other exemplary objectives and/or advantages of the disclosure, and the manner in which the same are accomplished, are further explained within the following detailed description and its accompanying drawings.

### BRIEF DESCRIPTION OF THE DRAWINGS

FIG. 1 is a schematic block-diagram of a display including pixel drivers for each pixel according to a possible implementation of the present disclosure.

FIG. 2 is a schematic block-diagram of a hybrid calibration source according to a possible implementation of the present disclosure.

FIG. 3A is a schematic block-diagram of a pixel in a calibration mode according to a possible implementation of the present disclosure.

FIG. 3B is a schematic block-diagram of a pixel in a radiation mode according to a possible implementation of the present disclosure.

FIG. 4 is a detailed schematic of a pixel for a micro-LED display according to a possible implementation of the present disclosure.

FIG. 5 is a flow chart of a method for driving a pixel in a display according to a possible implementation of the present disclosure.

The components in the drawings are not necessarily to scale relative to each other. Like reference numerals designate corresponding parts throughout the several views.

### DETAILED DESCRIPTION

A micro-LED display (i.e., display) has a backplane that includes a pixel driver circuit (i.e., pixel driver) for each pixel. Each pixel driver may include a current source, which can be biased to supply a substantially constant drive current. The pixel driver is configured to modulate the drive current ON/OFF based on a pulse width modulation (PWM) signal so that the micro-LED generates light having an intensity corresponding to the duty cycle of the PWM signal. A technical problem with micro-LED displays driven this way is that each current source may supply a slightly different drive current when biased using a common bias signal due to device variations. As a result, unwanted image artifacts may result from pixels driven with the same duty cycle but generating different intensities due to variations in their drive currents. To make matters worse, these variations can change over time due to factors, such as aging or temperature. The present disclosure describes a micro-LED display having pixel drivers for pixels that can be calibrated dynamically (e.g., periodically, as needed, etc.) to improve the precision of the drive currents generated for each pixel. This approach may have the technical effect of improving the intensity and the color rendered by the display and may help to compensate for variations due to environment and aging.

The current source for each may be implemented as a transistor biased to conduct a particular current level from a power supply. Variations in the transistor operating characteristics (e.g., threshold voltage) for each pixel may result from different material properties and fabrication results. As a result, driving each pixel with the same bias signal can lead to variations. Calibrating the transistors to determine the appropriate driving levels to generate the particular current level has been described in the patent, “EMISSIVE PIXEL ARRAY AND SELF-REFERENCING SYSTEM FOR DRIVING SAME,” U.S. Pat. No. 10,692,433 B2. The calibration described in this patent, however, may take longer than desirable to be applied dynamically. Dynamic calibration is a calibration that can occur (e.g., as needed) while the display is in use and can occur without noticeable interruption to the operation of the display.

The dynamic calibration disclosed here can be repeated at a frequency that can vary as needed. For example, a pixel having more leakage in a storage device used to store the calibration may be calibrated more than a pixel with less leakage in its storage device. This leakage may be based on temperature. Accordingly, the frequency of calibration may be adjusted based on a temperature of a pixel or pixels in the micro-LED display. The frequency may also be adjusted based on the settings and/or displayed content for the micro-LED display. For example, a course gray-scale resolution setting/content for the display may require calibration less often than a fine gray-scale resolution setting/content for the display. The frequency may also be user set, such as by a program setting for a controller on the micro-LED display.

The versatility of the dynamic calibration is due, in part, to the speed at which the calibration can be stored at the pixel. The disclosed micro-LED display includes a hybrid calibration source that can increase the speed at which the calibration can be stored at the pixel (e.g., as compared to other approaches), thereby allowing for the dynamic calibration described.

The pixel driver circuit disclosed herein can eliminate errors in storing the calibration and/or changes to the stored calibration by filtering or blocking signals in the pixel driver that could otherwise negatively affect (i.e., change, offset) the stored calibration. For example, the disclosed pixel driver includes isolation between coupling between current calibration circuitry in a current source portion of the pixel and driving circuitry in a PWM portion the pixel and driving circuitry.

The pixel driver circuit disclosed herein can improve the accuracy of the calibration by compensating for an unwanted voltage due to the circuitry (i.e., transistor) used for calibration. This unwanted voltage may be different for each pixel, as a result of the device variations. The disclosed compensation approach accommodates for this variation.

In other words, the present disclosure describes a pixel driver that includes circuitry to improve the precision and speed of calibration for each pixel driver in a display. In particular, the pixel driver of the present disclosure includes (i) a blocking transistor configured to isolate a current-source transistor during calibration, (ii) an isolation switch transistor configured to isolate a static random access memory (SRAM) during calibration, (iii) a compensating voltage source used to compensate for an unwanted voltage generated during calibration, and (iv) a hybrid calibration source configured to accelerate (i.e., speed-up) a charging process used during calibration. The result of at least these techniques is a pixel driver that can be dynamically calibrated with ultra-high precision and ultra-high speed as compared to other techniques.

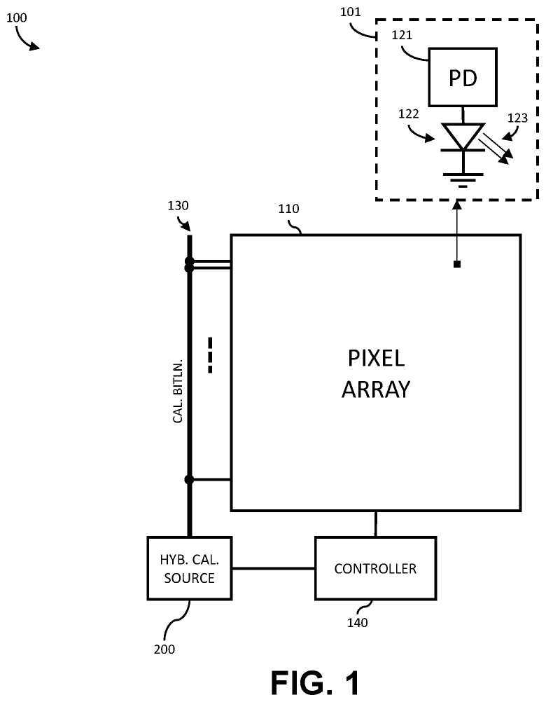

FIG. 1 is a schematic block-diagram of a micro-LED display (i.e., display) including pixel drivers for each pixel according to a possible implementation of the present disclosure. As shown the display 100 includes an array of pixels (i.e., pixel array 110). The pixel array 110 can include pixels arranged in rows and columns that can be addressed in a sequence to display frames. Each pixel 101 in the pixel array 110 includes a pixel driver 121 configured to supply modulated drive current (e.g., PWM current) to an LED 122 so that it projects light 123 at an intensity corresponding to the modulated drive current. The pixel drivers may each be coupled to a calibration bit line 130 so that a hybrid calibration source 200 can calibrate each pixel driver 121 before configuring it to supply the drive current to the LED. The calibration of the pixel drivers may occur at intervals (e.g., periodically). For example, a calibration period may occur after every Nth frame is displayed on the pixel array. The display 100 can include a controller 140 that can control the switches of the pixel array 110 and the hybrid calibration source 200 to operate the pixels in a calibration mode and a radiation mode.

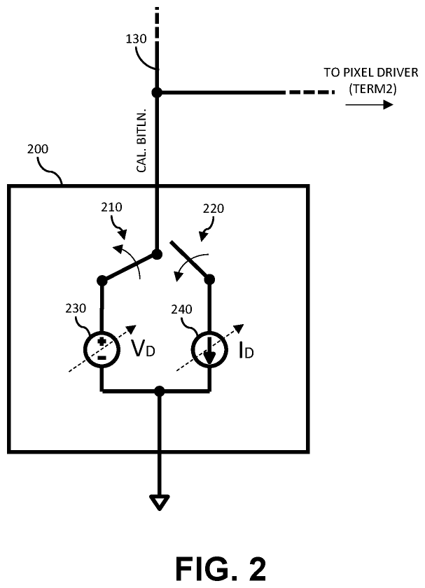

FIG. 2 is a schematic block-diagram of a hybrid calibration source according to a possible implementation of the present disclosure. The hybrid calibration source includes a voltage source 230 coupled to the calibration bit line 130 via a first switch 210 (i.e., voltage-source switch) and a current source 240 coupled to the calibration bit line 130 via a second switch 220 (i.e., current-source switch). In one possible implementation, all pixels are coupled to the same calibration bit line to share a common hybrid calibration source. In another possible implementation, a first portion of the pixels are coupled to a first calibration bit line and a second portion of the pixel are coupled to a second calibration bit line. The first bit line may be coupled to a first hybrid calibration source and the second bit line may be coupled to a second hybrid calibration source. The first hybrid calibration source and the second hybrid calibration source can be the same in their design and function. Any number of calibration bit lines and hybrid calibration sources may be included in a micro-LED display. An advantage to using multiple calibration bit lines is a shorter distance between a hybrid calibration source and a pixel, which could mitigate some parasitic effects associated with transmitting signals over long lines.

During a calibration period, a terminal of a pixel driver can be coupled to the calibration bit line 130. During the calibration period, the switches of the hybrid calibration source 200 can be switched alternatively so that either the voltage source 230 or the current source 240 is coupled to a terminal of the pixel driver via the calibration bit line 130. In other words, the calibration period can include a first phase and a second phase. During the first phase, the first switch 210 can be CLOSED (i.e., short circuited) and the second switch 220 can be OPEN (i.e., open circuited). During the second phase, the first switch 210 can be OPEN (i.e., open circuited) and the second switch 220 can be CLOSED (i.e., short circuited).

For example, the calibration period may include a first phase followed by a second phase. During the first phase (i.e., first portion) of the calibration period, the voltage source 230 can be configured to provide a calibrated voltage (VD) to the terminal (e.g., TERM2, second terminal 422) of the pixel 400 regardless of a current at the terminal, and during the second phase (i.e., second portion), the current source 240 can be configured to provide a calibrated current regardless of the voltage at the terminal of the pixel 400.

In the first phase, the voltage source 230 may be applied to a terminal of the charge-storage element to charge the charge-storage element (e.g., capacitor) to an approximate voltage (i.e., intermediate voltage). In the second phase, the current source 240 may be applied to the terminal of the charge-storage element to charge the charge storage element (e.g., capacitor) from the approximate voltage to the final calibration voltage. In other words, the first phase may roughly charge the charge storage element, while the second phase may fine tune the charge of the charge storage element.

The use of two calibration sources: the voltage source 230 and the current source 240 can help to reduce the time required for calibration (i.e., calibration period) because the current source may be relatively small (e.g., 1 microamp). Accordingly, using the current source alone could require a calibration period that is too long for some applications.

The voltage supplied by the voltage source 230 and the current supplied by the current source 240 may be fixed or variable with time. For example, the voltage supplied by the voltage source 230 may include a ramp portion that linearly increases in order to prevent transients, which could result from the resistance/capacitance response (i.e., RC response) of the calibration bit line 130.

The pixels in the micro-LED can be configured to operate in a calibration mode or a radiation mode. In the calibration mode, a pixel is coupled to the hybrid calibration source to generate a bias voltage (i.e., gate-source voltage) necessary for the pixel driver to supply a calibrated current. In the radiation mode, the pixel is decoupled from the hybrid calibration source and the pixel driver uses the gate-source voltage obtained during the calibration period to generate the calibrated current. The pixels in the micro-LED display may use a variety of different gate-source voltages to supply the same calibrated current. The calibration mode and the radiation mode of a pixel may be controlled with switches (e.g., transistors).

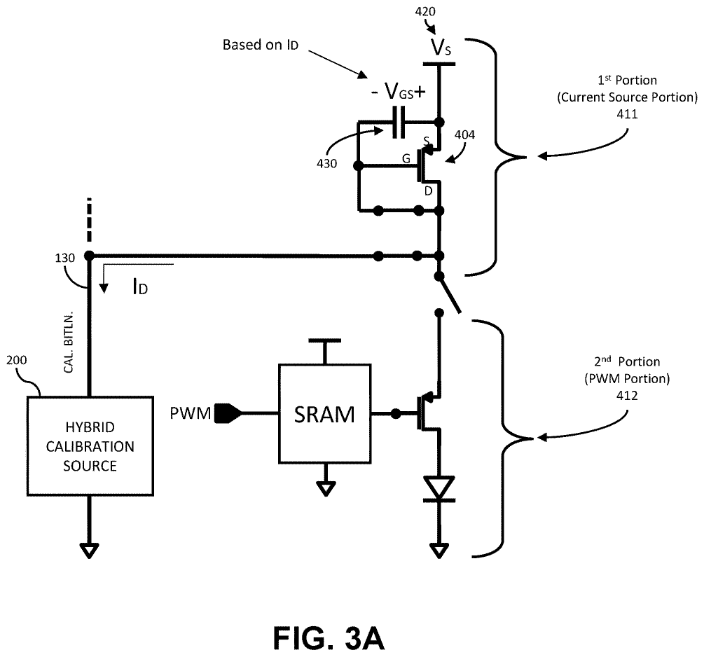

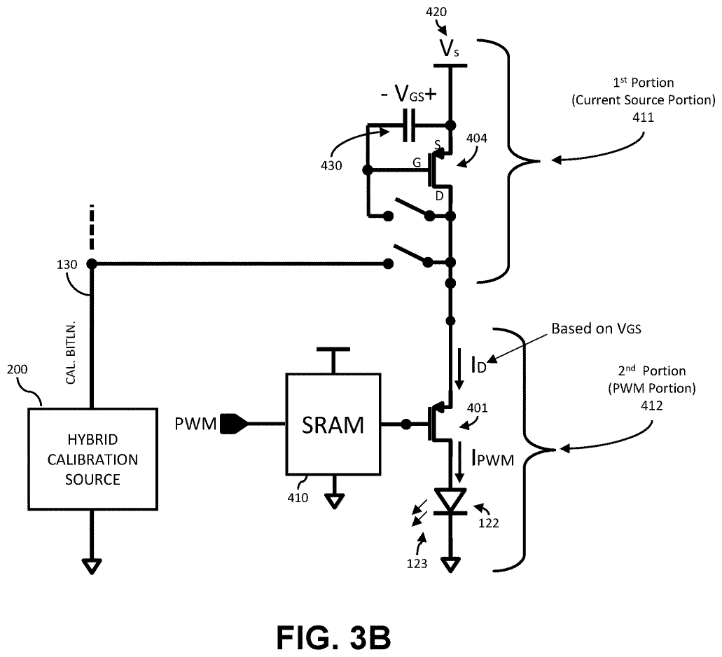

FIG. 3A is a schematic block-diagram of a pixel in a calibration mode according to a possible implementation of the present disclosure. The pixel includes a first portion 411 (i.e., current source portion) configured to source a current for the pixel. The pixel also includes a second portion 412 (i.e., PWM portion) configured to modulate the current and illuminate an LED 122.

As shown in FIG. 3A, in the calibration mode, the second portion 412 is decoupled from the first portion 411. In the calibration mode, the second portion 412 is coupled to the calibration bit line 130. In the calibration mode, a drain terminal (D) of the current-source transistor 404 is coupled to a gate terminal (G) of the current-source transistor 404. The shorted drain and gate terminals configure the current-source transistor 404, which is a p-type metal oxide semiconductor (PMOS) transistor, to function as a diode coupled between the power supply 420 and the hybrid calibration source 200. The diode is forward biased and conducts current according to the hybrid calibration source 200. During the calibration period, a charge-storage element 430, which coupled between the gate terminal (G) and a source terminal(S) of the current-source transistor 404, is charged to a gate-source voltage (V_{GS}) necessary for the current-source transistor 404 to conduct the calibrated current (ID) sourced by the hybrid calibration source 200. Note, because the current-source transistor 404 is a PMOS transistor the gate-source voltage (V_{GS}) will be negative (i.e., the gate voltage will be less than the source voltage) while current-source transistor 404 conducts, as indicated in FIG. 3A.

FIG. 3B is a schematic block-diagram of a pixel in a radiation mode according to a possible implementation of the present disclosure. In the radiation mode, the second portion 412 is decoupled from the calibration bit line 130 and is coupled (e.g., recouple) to the first portion 411. In the radiation mode, a drain terminal (D) of the current-source transistor 404 is decoupled from gate terminal (G) of the current-source transistor 404. During the radiation mode, the first portion 411 is configured to generate the calibrated current (ID) based on the gate-source voltage (V_{GS}) stored in the charge-storage element 430. The calibrated current (ID) is transmitted from the first portion 411 to the second portion 412. The second portion 412 includes a modulation transistor 401. The modulation transistor 401 can be configured ON (i.e., conducting) or OFF (i.e., not conducting) based on a PWM signal 106. The PWM signal may be coupled to the modulation transistor 401 via a static random access memory (SRAM) cell 410. The SRAM cell may store/output the ON/OFF state of the PWM signal until it is changed. A PWM current (IPWM) is generated by the ON/OFF modulation applied by the modulation transistor 401. The PWM current is converted to light 123 by the light emitting diode (LED 122).

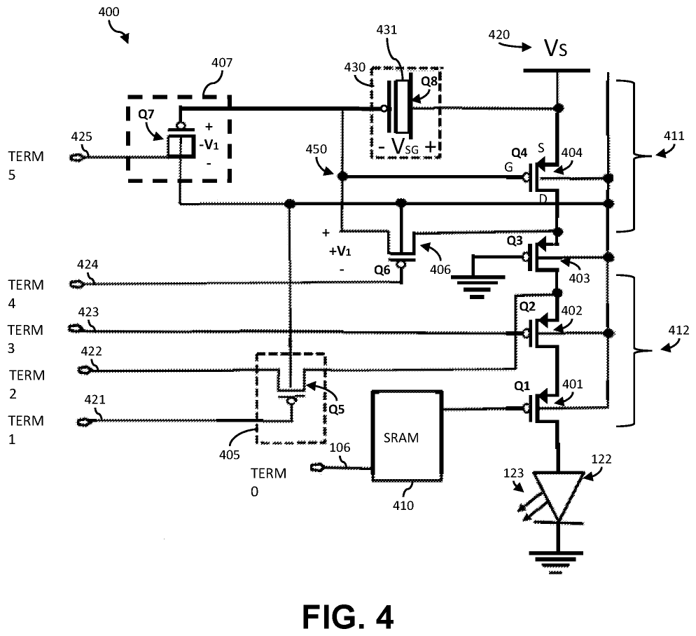

FIG. 4 is a detailed schematic of an LED and pixel driver circuit (i.e., pixel 400) according to a possible implementation of the present disclosure. The pixel 400 includes a current-source transistor 404 (Q4) that can be configured by a voltage on a controlling terminal (e.g., gate terminal) to conduct a drive current from a power supply 420 when gate-source voltage (V_{GS}) is applied to the current-source transistor 404 between a source terminal(S) and a drain terminal (D). As shown the current-source transistor (Q4) may be a P-type metal oxide semiconductor (PMOS) transistor, which is ON (i.e., conducting) while a relatively low voltage is applied to the gate terminal (G).

The pixel 400 further includes a modulation transistor 401 (Q1) that can be configured in the ON state (i.e., ON) to conduct the drive current or can be configured in the OFF state (i.e., OFF) to not conduct (i.e., block) the drive current to the LED. The ON/OFF state of the modulation transistor 401 (Q1) can control the apparent intensity of the LED 122. Accordingly, a pulse-width modulation (PWM) sequence of ON/OFF signals may be buffered and/or stored in a memory module (e.g., SRAM cell 410) and transmitted to a controlling terminal (i.e., gate terminal) of the modulation transistor 401 (Q1). The PWM sequence may control the LED ON/OFF according to a duty cycle so that the LED 122 (i.e., pixel) projects light 123 at a particular intensity.

The current-source transistor 404 (Q4) and the modulation transistor 401 (Q1) perform the primary functions of the pixel driver in the drive mode (i.e., radiation mode). When the pixel 400 is an a radiation mode, the current-source transistor 404 (Q4) is ON and driven (at a calibrated drive level) to conduct the drive current at a predetermined (and fixed) level (e.g., 1 μA), while the modulation transistor 401 (Q1) is toggled ON/OFF according to a modulation (e.g., provided by the SRAM cell 410) to set the intensity of the light 123 emitted by the LED 122.

To reduce artifacts (i.e., pixel-to-pixel intensity variation), the drive current for each pixel (i.e., each pixel 400) may be made substantially equal. The drive current corresponds to a drive level applied to the current-source transistor 404 (Q4). When the current-source transistor 404 (Q4) is implemented as a PMOS transistor, the drive level corresponds to the gate-source voltage (V_{GS}), which can be negative in PMOS transistors, and a threshold voltage (VT), which can be negative in PMOS transistors. In other words, the current may be based on how much lower (e.g., more negative) Vas is than VT. The gate-source voltage (V_{GS}) is applied to the transistor and can be controlled, while the threshold voltage (VT) is based on its fabrication process and cannot be controlled with a precision sufficient necessary to remove visual artifacts (e.g., <3% difference).

The pixel 400 (for each pixel) may be operated in a calibration mode to determine the drive level (e.g., V_{GS}−V_{T}) necessary to obtain a predetermined drive current (e.g., 1 μA). In the calibration mode, the gate-source voltage (V_{GS}) necessary for the current-source transistor 404 to conduct the predetermined drive current may be determined (i.e., measured, calibrated, etc.) and stored. The stored gate-source voltage (V_{GS}) may be used in a subsequent radiation mode so that the current-source transistor 404 (Q4) can be driven at the proper drive level (V_{GS}−V_{T}) to conduct the predetermined drive current.

The pixel 400 further includes a blocking transistor 403 (Q3). As shown, the blocking transistor 403 is implemented as a PMOS transistor. A gate terminal of the blocking transistor 403 (Q3) is permanently coupled (e.g., directly connected) to a ground to configure the transistor in an ON condition. In the ON condition the blocking transistor 403 (Q3) can conduct the drive current. The blocking transistor 403 can also attenuate (e.g., block) high-frequency signals with a capacitance that is inherent to the blocking transistor 403 (Q3). The blocking transistor 403 can include a gate-to-drain capacitance (CGD), a gate-source capacitance (Cas), and a drain-to-source capacitance (CDS), which alone or in combination, can act as a blocking capacitor to isolate a first portion 411 of circuitry coupled to the source of the blocking transistor 403 from a second portion 412 of circuitry coupled to the drain of the blocking transistor 403.

The blocking transistor 403 (Q3) can reduce (e.g., prevent) voltage variations on the drain of the current-source transistor 404, which could affect the calibration process. In particular, voltage fluctuations (voltage drift) at the drain (D) of the current-source transistor 404 can be conveyed to the gate (G) of the current-source transistor 404 through a Miller capacitance (e.g., C_{DS}, C_{GS}, and/or C_{GD}). This blocking can help the calibration by improving an accuracy of the measured gate-source voltage (V_{GS}) required for a given drive current. For example, when the gate of the current-source transistor 404 is blocked by the blocking transistor 403, the measured gate-source voltage (V_{GS}) accuracy can be less than 1% (e.g., within 1 millivolt of its actual value). The direct connection of the blocking transistor 403 gate to ground can provide a gate-source capacitance (C_{GS}) that is very stable. In other words, the ground connection at the gate can function as a capacitance stabilizer for the blocking transistor 403.

The calibration can affect the state (i.e., status) of the SRAM cell 410. In other words, voltages coupled to the SRAM cell 410 during a calibration process can cause errors in the stored data. While the SRAM can be cleared (i.e., reset) prior to calibration to prevent the negative effects of calibration, this approach takes time, especially when the SRAM cell 410 for each pixel is large (e.g., >1 million memory locations). Clearing the SRAM cell 410 effectively turns the modulation transistor 401 OFF during calibration.

Accordingly, the pixel 400 further includes an isolation transistor 402 (Q2). As shown, the isolation transistor 402 is implemented as a PMOS transistor. The isolation transistor 402 may be configured by a signal at a third terminal 423 (TERM3), which is coupled to a gate terminal of the isolation transistor 402. The isolation transistor 402 may be configured in an OFF condition (i.e., blocking) while the pixel 400 is operated in the calibration mode and an ON condition (i.e., conducting) while the pixel 400 is operated in the radiation mode. The OFF condition of the isolation transistor 402 may decouple the SRAM cell 410 from calibration circuitry of the pixel 400 during the calibration mode. This decoupling can allow the SRAM cell 410 to remain substantially the same before and after a calibration process, which can increase the speed of the calibration process because clearing the SRAM prior to calibration and then reloading the SRAM after calibration can take time. The OFF condition of the isolation transistor during calibration allows Q1 to be ON or OFF during the calibration mode of operation.

The ON/OFF switching of the isolation transistor 402 may be blocked from affecting the current-source transistor 404 by the isolation transistor 402. Without this blocking, toggling the voltage at the gate of the isolation transistor 402 can be coupled through a Miller capacitance to a gate of the current-source transistor 404.

The pixel 400 further includes a calibration transistor 406 (Q6). As shown, the calibration transistor 406 is implemented as a PMOS transistor. The calibration transistor 406 may be configured by a signal at a fourth terminal 424 (TERM4), which is coupled to a gate terminal of the calibration transistor 406. The calibration transistor 406 can be configured in an ON condition (i.e., conducting) while the pixel 400 is operated in the calibration mode and in an OFF condition (i.e., blocking) while the pixel 400 is operated in the radiation mode. In the ON condition, the calibration transistor 406 can short circuit the drain terminal of current-source transistor 404 to the gate terminal of the current-source transistor. In this condition, the current-source transistor 404 (Q4) operates as a diode-connected transistor. The diode-connected transistor may generate the calibrated gate-source voltage (V_{GS}) when it is made to conduct the (predetermined) drive current.

The pixel 400 further includes a charge-storage element 430 configured to store the gate-source voltage (V_{GS}) generated by the current-source transistor 404 (Q4), while configured as the diode-connected transistor in the calibration mode. As shown, the charge-storage element 430 can be implemented as a capacitance between a gate terminal and a body terminal (i.e., substrate) of a storage transistor 431 (Q8). The body terminal (i.e., back gate) of the storage transistor 431 (Q8) may be coupled to a voltage (V_{LED}) of the power supply 420 and the gate terminal of the storage transistor 431 (Q8) may be coupled to a gate terminal of the current-source transistor 404 (Q4). The calibrated voltage (V_{GS}) stored in the storage transistor 431 (Q8) may be used until it changes (e.g., due to leakage) by an amount sufficient to require another calibration.

The gate terminal of the storage transistor 431 (Q8) is also coupled to a compensation transistor 407 (Q7). The compensation transistor 407 (Q7) is included to cancel voltages (i.e., unwanted voltage) coupled by the calibration transistor 406 (Q6) so that they do not negatively affect the stored gate-source voltage (V_{GS}). The cancellation can prevent the switching of the calibration transistor 406 (Q6) from affecting the voltage (V_{GS}) stored in the charge-storage element 430. The calibration (i.e., stored V_{GS}) may therefore be made more accurate.

The compensation transistor 407 (Q7) is configured, by a signal at the fifth terminal 425 (TERM5), in an OFF condition while the calibration transistor 406 is in an ON condition, and vice versa. In other words, a signal at fifth terminal 425 (TERM5) can be the complement of the signal at the fourth terminal 424 (TERM4). When a HIGH signal at the fourth terminal 424 turns the calibration transistor 406 (Q6) OFF, the gate of the storage transistor (Q8) may be increased by a voltage (i.e., +V₁) due to capacitive coupling in the calibration transistor 406 (Q6). At the same time, a LOW signal at the fifth terminal 425 can decrease the gate of the storage transistor (Q8) by the same voltage (i.e., −V₁) so that the net effect is approximately zero volts added to (or subtracted from) the stored voltage (V_{GS}). Accordingly, Q7 and Q6 may be matched to have substantially the same size so that the voltages (+V₁, −V₁) can be approximately (e.g., <3%) the same (e.g., equal).

The pixel 400 further includes a calibration-source transistor 405 (Q5). As shown, the calibration-source transistor 405 is implemented as a PMOS transistor. The calibration-source transistor 405 may be configured by a signal at a first terminal 421 (TERM1), which is coupled to a gate terminal of the calibration-source transistor 405 (Q5), to conduct a drive current to a second terminal 422 (TERM2) during a calibration mode. TABLE 1 below summarizes the states of the switchable transistors (Q1-Q6) of the pixel 400 in the calibration mode and the radiation mode.

TABLE 1
SWITCHING STATES OF TRANSISTORS
IN THE PIXEL DRIVE

| | TRANSISTOR | | | | | |
|---|---|---|---|---|---|---|
| MODE | Q1 | Q2 | Q3 | Q4 | Q5 | Q6 |
| CALIBRATION | ON/OFF | OFF | ON | ON | ON | ON |
| RADIATION | ON/OFF | ON | ON | ON | OFF | OFF |

The effects of the blocking transistor 403, isolation transistor 402 and the compensation transistor 407 can increase the accuracy of the calibration (e.g., 3-5%), which can correspond to high uniformity (e.g., >98%) of the intensity of pixels in the pixel array.

The second terminal 422 (TERM2) is coupled to a hybrid calibration source 200. As shown in FIG. 1, the hybrid calibration source 200 may be shared between pixel drivers of a pixel array 110 using a calibration bit line 130. In calibration mode, a drive current flows through the current-source transistor 404 (Q4), the blocking transistor 403 (Q3), and the calibration-source transistor 405 (Q5) as the charge-storage element 430 is slowly charged (i.e., until a gate node 450 reaches an equilibrium). The drive current used for calibration (i.e., the predetermined drive current) may be too small (e.g., 1 microamp) to quickly charge the charge-storage element 430. As a result, the calibration process may take a relatively long period of time for the gate node 450 to reach its final value. The present disclosure includes a hybrid calibration source that can decrease the time required for calibration (i.e., a calibration period).

FIG. 2 is a schematic block-diagram of a hybrid calibration source according to a possible implementation of the present disclosure. The hybrid calibration source 200 includes a voltage source 230 coupled to a calibration bit line 130 via a first switch 210 and a current source 240 coupled to the calibration bit line 130 via a second switch 220. The current source 240 is configured to provide the drive current at the desired value for calibration (e.g., 1 microamp) regardless of the voltage at the second terminal 422 (TERM2) of the pixel 400. The voltage source 230 is configured to provide a drive voltage regardless of a current at the second terminal 422 (TERM2) of the pixel 400.

The calibration period may include two phases: a first phase followed by a second phase. The calibration period may conclude when the gate node 450 reaches a stable value. In the first phase, the first switch 210 is ON (i.e., closed) and the second switch 220 is OFF (i.e., open). In the second phase, the first switch 210 is OFF (i.e., open) and the second switch 220 is ON (i.e., closed).

In the first phase, the voltage source 230 is coupled to the gate node 450 through the calibration-source transistor 405, the blocking transistor 403, and the calibration transistor 406, which are all ON in the calibration mode. As a result, the gate node 450 is forced to the voltage of the voltage source 230. The voltage source 230, which is not current limited, can quickly charge the storage transistor 431 to an intermediate voltage that is some percentage (e.g., 90%) of the calibration voltage (V_{GS}).

In the second phase, the current source 240 is coupled to the gate node 450 through the calibration-source transistor 405, the blocking transistor 403, and the calibration transistor 406, which are all ON in the calibration mode. The current source 240 draws the desired drive current through the (diode-connected) current-source transistor 404 (Q4), the blocking transistor 403 (Q3), and the calibration-source transistor 405 (Q5) to a ground at the hybrid calibration source 200.

The regulated current drawn by the current source 240 finishes charging the storage transistor 431 to the calibration voltage (V_{GS}). For example, the current source can be connected by the second switch 220 to the second terminal 422 (TERM2) for a fixed amount of time (e.g., 5 nanoseconds) to finish the charging necessary for calibration. The fixed amount of time can be determined (e.g., based on circuit simulations and/or experimentation) prior to implementing a calibration process.

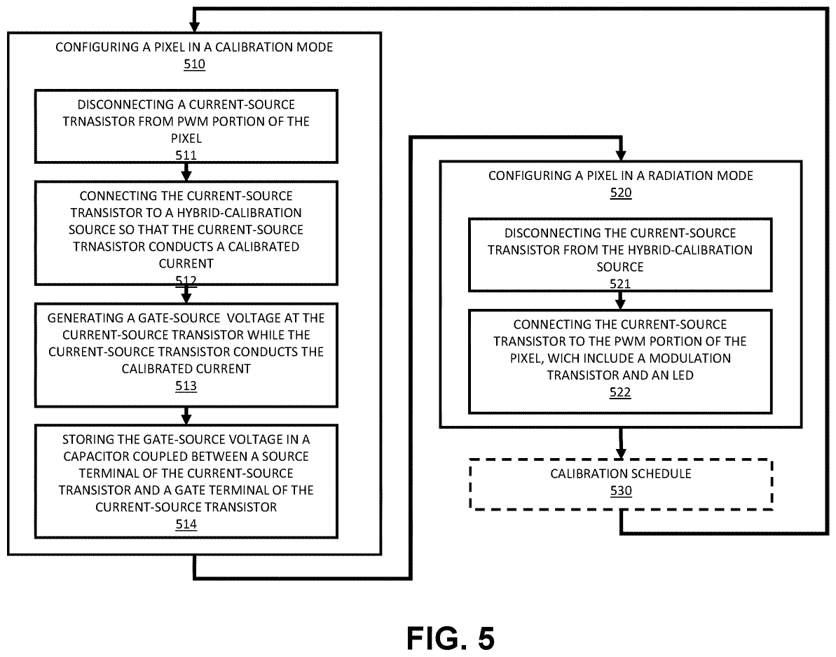

FIG. 5 is a flow chart of a method for driving a pixel in a display according to a possible implementation of the present disclosure. The method includes configuring 510 a pixel in a calibration mode (e.g., see FIG. 3A). The configuration into the calibration mode may include disconnecting 511 the current-source transistor from a PWM portion of the pixel and connecting 512 the current-source transistor to a hybrid-calibration source so that the current-source transistor conducts a calibrated current (ID). The method further includes generating 513 a gate-source voltage at the current-source transistor while the current source transistor conducts the calibrated current. The method further includes storing 514 the gate-source voltage in a capacitor coupled between a source terminal and the gate terminal of the current-source transistor. The method further includes configuring 520 the pixel in a radiation mode by disconnecting 521 the current-source transistor from the hybrid-calibration source and connecting 522 the current-source transistor to the PWM portion of the pixel. The method can further include biasing the current-source transistor to conduct the calibrated current based on the gate-source voltage stored in the capacitor (i.e., during the calibration period). The method can further include receiving the calibrated current at a modulation transistor and controlling the modulation transistor ON/OFF with a PWM signal to generate a PWM current. The method can further include radiating light at an LED coupled to the modulation pixel based on the PWM current. The method may further include repeating the calibration process based on a calibration schedule 530. The calibration schedule can specify when to calibrate (e.g., a calibration frequency) based on the gray-scale resolution of the display. The calibration schedule can specify when to calibrate (e.g., a calibration frequency) based on a leakage current of the capacitor. The calibration schedule can specify when to calibrate (e.g., a calibration frequency) based on the temperature of the micro-LED display (e.g., temperature of an LED).

Some implementations may be implemented using various semiconductor processing and/or packaging techniques. Some implementations may be implemented using various types of semiconductor processing techniques associated with semiconductor substrates including, but not limited to, for example, Silicon (Si), Gallium Arsenide (GaAs), Gallium Nitride (GaN), Silicon Carbide (SiC) and/or so forth.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

It will be understood that, in the foregoing description, when an element is referred to as being on, connected to, electrically connected to, coupled to, or electrically coupled to another element, it may be directly on, connected or coupled to the other element, or one or more intervening elements may be present. In contrast, when an element is referred to as being directly on, directly connected to or directly coupled to another element, there are no intervening elements present. Although the terms directly on, directly connected to, or directly coupled to may not be used throughout the detailed description, elements that are shown as being directly on, directly connected or directly coupled can be referred to as such. The claims of the application, if any, may be amended to recite exemplary relationships described in the specification or shown in the figures.

As used in this specification, a singular form may, unless definitely indicating a particular case in terms of the context, include a plural form. Spatially relative terms (e.g., over, above, upper, under, beneath, below, lower, and so forth) are intended to encompass different orientations of the device in use or operation in addition to the orientation depicted in the figures. In some implementations, the relative terms above and below can, respectively, include vertically above and vertically below. In some implementations, the term adjacent can include laterally adjacent to or horizontally adjacent to.

1. A pixel comprising:
a first portion including:
a current-source transistor coupled at a source terminal to a power supply; and
a charge-storage element coupled between a gate terminal of the current-source transistor and the source terminal of the current-source transistor;
a calibration transistor configured to couple the gate terminal of the current-source transistor to a drain terminal of the current-source transistor while the pixel is in a calibration mode; and
a calibration-source transistor configured to couple the drain terminal of the current-source transistor to a hybrid calibration source while the pixel is in the calibration mode, the hybrid calibration source configured to charge the charge-storage element to a gate-source voltage during a calibration period so that the current-source transistor conducts a calibrated current after the calibration period.

2. The pixel according to claim 1, wherein:
the calibration transistor generates an unwanted voltage at the gate terminal of the current-source transistor during the calibration period; and
the pixel, for increasing an accuracy of the gate-source voltage stored in the charge-storage element, further includes:
a voltage source configured to cancel the unwanted voltage at the gate terminal of the current-source transistor during the calibration period.

3. The pixel according to claim 1, wherein:
the hybrid calibration source includes a voltage source and a current source;
the voltage source is coupled to the calibration-source transistor by a first switch; and
the current source is coupled to the calibration-source transistor by a second switch.

4. The pixel according to claim 3, wherein:
the calibration period incudes a first phase and a second phase;
the first switch is CLOSED and the second switch is OPEN during the first phase; and
the first switch is OPEN and the second switch is CLOSED during the second phase.

5. The pixel according to claim 1, further comprising:
a second portion including:
a light emitting diode (LED); and
a modulation transistor coupled between the LED and the current-source transistor while the pixel is in a radiation mode, the modulation transistor being configurable in an ON-condition to conduct the calibrated current to the LED so that the LED emits light or in an OFF-condition to block the calibrated current from the LED so that the LED does not emit light; and
an isolation transistor coupled between the current-source transistor and the modulation transistor, wherein the isolation transistor is configured to:
decouple the first portion and the second portion when the pixel is in the calibration mode; and
couple the first portion and the second portion when the pixel is in the radiation mode.

6. The pixel according to claim 5, further comprising:
a blocking transistor configured to block switching signals from the second portion, during the radiation mode, in order to prevent the switching signals from changing the gate-source voltage.

7. The pixel according to claim 6, wherein:
the blocking transistor is a p-type transistor coupled between the current-source transistor and the isolation transistor; and
a gate terminal of the blocking transistor is coupled to a ground.

8. The pixel according to claim 5, wherein a gate terminal of the modulation transistor is coupled to a static random access memory (SRAM) cell.

9. The pixel according to claim 8, wherein the SRAM cell is configured in a first state or a second state by a pulse width modulation (PWM) signal.

10. The pixel according to claim 1, wherein the charge-storage element is a metal oxide semiconductor field effect transistor (MOSFET) configured as a capacitor.

11. A micro-light-emitting-diode (micro-LED) display, comprising:
the hybrid calibration source; and
at least one pixel according to claim 1.

12. A method for driving a pixel in a display, the method comprising:
configuring the pixel in a calibration mode by:
disconnecting a current-source transistor from a pulse width modulation (PWM) portion of the pixel; and
connecting the current-source transistor to a hybrid-calibration source so that the current-source transistor conducts a calibrated current;
generating a gate-source voltage at the current-source transistor while the current-source transistor conducts the calibrated current;
storing the gate-source voltage in a capacitor coupled between a source terminal of the current-source transistor and a gate terminal of the current-source transistor; and
configuring the pixel in a radiation mode by:
disconnecting the current-source transistor from the hybrid-calibration source; and
connecting the current-source transistor to the PWM portion of the pixel, the PWM portion including a modulation transistor and a light emitting diode (LED).

13. The method according to claim 12, further comprising, while in the radiation mode:
biasing the current-source transistor to conduct the calibrated current based on the gate-source voltage stored in the capacitor;
receiving the calibrated current at the modulation transistor;
controlling the modulation transistor ON and OFF with a PWM signal to generate a PWM current; and
radiating light at the LED based on the PWM current.

14. The method according to claim 12, wherein:
the hybrid-calibration source is coupled to a plurality of pixels in the display by a calibration bit line; and
the hybrid-calibration source includes a voltage source and a current source.

15. The method according to claim 14, wherein storing the gate-source voltage in the capacitor coupled between the source terminal and the gate terminal of the current-source transistor includes:
coupling the gate terminal of the current-source transistor to a drain terminal of the current-source transistor, the drain terminal coupled to the hybrid-calibration source;
coupling the voltage source of the hybrid-calibration source to the drain terminal;
charging the capacitor to an approximate voltage using the voltage source;
replacing the voltage source at the drain terminal with the current source of the hybrid-calibration source; and
charging the capacitor from the approximate voltage to the gate-source voltage using the current source.

16. The method according to claim 15, wherein coupling the gate terminal of the current-source transistor to the drain terminal of the current-source transistor includes:
activating a calibration transistor to couple the gate terminal and the drain terminal, the calibration transistor generating a first voltage between the gate terminal and the drain terminal; and
applying a second voltage to the gate terminal to cancel the first voltage generated by the calibration transistor.

17. The method according to claim 16, wherein the second voltage is generated by a transistor having a first size to match a second size of the calibration transistor.

18. The method according to claim 12, wherein placing the pixel in the calibration mode is based on a schedule, the schedule having a calibration frequency based on a gray-scale resolution of the display.

19. The method according to claim 12, wherein placing the pixel in the calibration mode is based on a schedule, the schedule having a calibration frequency based on a leakage current of the capacitor.

20. The method according to claim 12, wherein placing the pixel in the calibration mode is based on a schedule, the schedule having a calibration frequency based on a temperature of the LED.

21. A micro-light-emitting-diode (micro-LED) display, comprising:
a hybrid calibration source coupled to a calibration bit line; and
a plurality of pixels, each pixel including:
a current-source transistor coupled at a source terminal to a power supply;
a charge-storage element coupled between a gate terminal of the current-source transistor and the source terminal of the current-source transistor;
a calibration transistor configured to couple the gate terminal of the current-source transistor to a drain terminal of the current-source transistor during a calibration period; and
a calibration-source transistor configured to couple the drain terminal of the current-source transistor to the calibration bit line during the calibration period so that the hybrid calibration source charges the charge-storage element to a gate-source voltage corresponding to a calibrated current.

22. The micro-LED display according to claim 21, wherein:
the hybrid calibration source includes a voltage source and a current source;
the voltage source is coupled to the calibration bit line by a first switch;
the current source is coupled to the calibration bit line by a second switch;
the first switch is configured to be CLOSED while the second switch is OPEN during a first phase of the calibration period; and
the second switch is configured to be CLOSED while the first switch is OPEN during a second phase of the calibration period.
